(19) United States
(12) Patent Application Publication
(10) Pub. No.: US 2025/0291533 A1
(43) Pub. Date: Sep. 18, 2025

(54) INDUSTRIAL PRINTING SYSTEM, PRINT SERVER, AND PROCESS MANAGEMENT METHOD THAT PERFORMS PEER-TO-PEER DISTRIBUTED PROCESSING OF PRODUCTION PRINTING BASED ON LICENSES FOR AVAILABLE FUNCTIONS

(71) Applicant: KYOCERA Document Solutions Inc., Osaka (JP)

(72) Inventor: Taku MATSUO, Los Angeles, CA (US)

(73) Assignee: KYOCERA Document Solutions Inc., Osaka (JP)

(21) Appl. No.: 18/603,598

(22) Filed: Mar. 13, 2024

(51) Int. Cl. G06F 3/12

(52) U.S. Cl. CPC G06F 3/1261; G06F 3/1205; G06F 3/1226; G06F 3/1282; G06F 3/1285

(57) ABSTRACT

Provided is an industrial printing system that efficiently performs peer-to-peer distributed processing for production printing without requiring manual intervention. The system has a plurality of print servers that perform distributed processing of a job. Each of the plurality of print servers includes a storage unit, a processing determination unit, and a processing management unit. The storage unit stores license information including function information of an available distribution destination for distributed processing. The processing determination unit determines other print server that can process the job based on the license information stored in the storage unit. The processing management unit sends the job to the other print server determined to be capable of processing by the processing determination unit and requests processing.

### BACKGROUND

The present disclosure relates to an industrial printing system for industrial printing (production printing) that performs distributed processing, a print server, and a processing management method.

Among typical printing systems including a plurality of printers, there is a printing system that performs so-called ubiquitous printing. This system is a print system that includes a plurality of printers (MFPs), and when the job is received from the PC that issued the ubiquitous job, the first MFP stores the print settings in the memory if the print settings can be processed by its own print function. If it cannot be processed, it is transferred to the next MFP. This process is performed in a predefined order from the first MFP to the Nth MFP. Thus, the ubiquitous job is stored in the memory of the MFP that can process it. As a result, in the printing system, the waiting time for the user to obtain printed matter can be reduced.

In other words, in this typical technology, print data (jobs) are transferred to each MFP as they are, and the transferred MFP itself determines whether it is capable of processing them or not.

On the other hand, in industrial printing called production printing, which uses commercial (industrial) printing apparatus, components of the final product are manufactured by dividing labor into a plurality of processes. For example, in the case of bookbinding, the cover, main body (color), main body (monochrome), promotional materials, bands, shipping envelopes, or the like, are processed as different jobs. Then, in the middle of the process, each job is combined to obtain the final product, a book.

### SUMMARY

An industrial printing system according to the present disclosure is an industrial printing system that performs production printing having a plurality of print servers that perform distributed processing of a job, each of the plurality of print servers including; a storage unit that stores license information having function information of an available distribution destination for the distributed processing; a processing determination unit that determines other print server capable of processing the job based on the license information stored in the storage unit; and a processing management unit that sends the job to the other print server determined to be capable of processing by the processing determination unit and requests processing.

A print server according to the present disclosure is a print server that performs distributed processing of a job in an industrial printing system that performs production printing, including: a storage unit that stores license information having function information of an available distribution destination for the distributed processing; a processing determination unit that determines other print server capable of processing the job based on the license information stored in the storage unit; a processing management unit that sends the job to the other print server determined to be capable of processing by the processing determination unit and requests processing.

A processing management method according to the present disclosure is a processing management method executed by an industrial printing system that performs production printing and has a plurality of print servers that perform distributed processing of jobs, including the steps of: storing license information having function information of an available distribution destination for the distributed processing; determining other print server capable of processing the job based on the stored license information; sending the job to the other print server that is determined to be capable of processing; and requesting processing the job.

### BRIEF DESCRIPTION OF THE DRAWINGS

FIG. 1 is an example of a system configuration diagram of an industrial printing system according to an embodiment of the present disclosure;

FIG. 2 is a block diagram showing a control configuration of the print server as shown in FIG. 1;

FIG. 3 is a block diagram showing a functional configuration of the print server as shown in FIG. 1;

FIG. 4 is a block diagram showing details of the license information as shown in FIG. 3;

FIG. 5 is a block diagram showing details of the job as shown in FIG. 3;

FIG. 6 is a flowchart of licensing distribution job process according to an embodiment of the present disclosure; and

FIG. 7 is a conceptual diagram of job processing request and delivery in the licensing distribution job process as shown in FIG. 4.

### DETAILED DESCRIPTION

### Embodiment

### [Configuration of Industrial Printing System X]

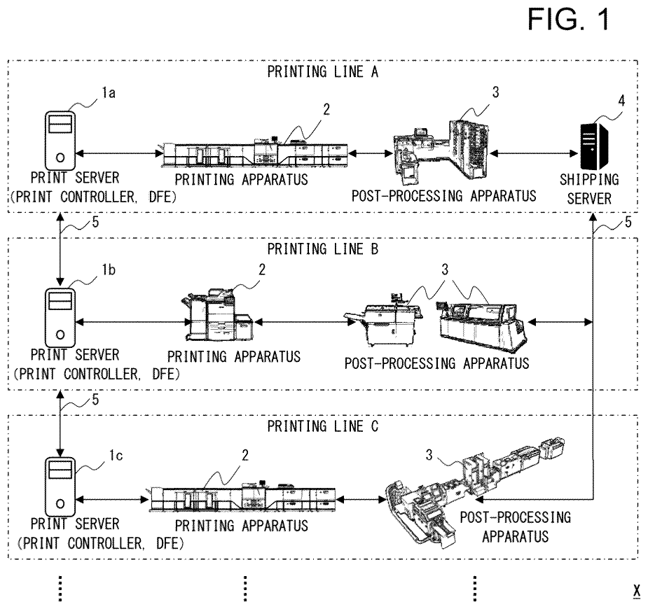

Firstly, with reference to FIG. 1, an example of the overall system configuration of the industrial printing system X according to the present embodiment is described.

The industrial printing system X according to the present embodiment is a system that executes output by a printing process and a post-processing process (hereinafter also simply referred to as “printing”) in industrial printing (production printing).

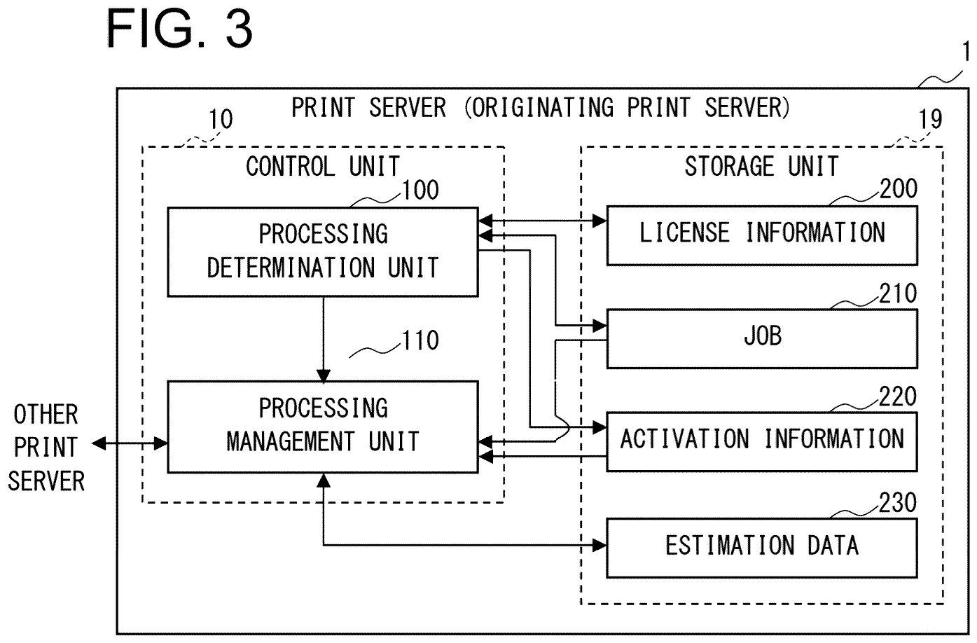

Here, in the industrial printing system X of the present embodiment, the final product such as a book to be output is referred to as an “order,” and each component of the order is referred to as a job 210 (FIG. 3).

In the industrial printing system X, printing lines of printing companies, printing plants, or the like (hereinafter referred to as “sites”), are connected and linked by a network 5. The site includes a print server land component apparatuses, which includes printing apparatuses 2, post-processing apparatuses 3, shipping servers 4, or the like.

In FIG. 1, as an example of cooperation between sites, each of the print servers 1a, 1b, 1c, . . . of the print lines A, B, C, . . . and the shipping server 4 of print line A are connected via a network 5. Further, in this example, the printing apparatuses 2a, 2b, 2c, . . . and the post-processing apparatuses 3a, 3b, 3c, . . . are connected with the printing lines A, B, C, . . . .

Hereinafter, if any one of these print servers 1a, 1b, 1c, . . . is indicated, it is simply referred to as the print server 1. Similarly, if any one of these printing apparatuses 2a, 2b, 2c, . . . is indicated, it is simply referred to as the printing apparatus 2. Similarly, if any one of the post-processing apparatuses 3a, 3b, 3c, . . . is indicated, it is simply referred to as the post-processing apparatus 3.

The print server 1 is an information processing apparatus that serves as a print controller or DFE (Digital Front End) for managing and controlling each of component apparatuses provided at each site. The print server 1 is configured with a PC (Personal Computer) server, a dedicated machine, a general-purpose machine, and the like.

In the present embodiment, the print server 1 executes a dedicated print management application software (hereinafter simply referred to as an “application”) to perform peer-to-peer distributed processing of a job 210 (FIG. 3) for production printing. This print management application (hereinafter referred to as a “dedicated application”) may also be implemented with a common platform capable of creating a print design, user management, tenant management, security management, maintenance notification service, prepress processing management, storage management of each document, and management of the printing apparatus 2.

Specifically, the print server 1 sends and receives various instructions and information to and from the printing apparatus 2, the post-processing apparatus 3, the shipping server 4, or the like, in production printing. Thereby, the print server 1 manages the status of each apparatus and requests processing of the job 210.

In the present embodiment, the print server 1 on the processing requesting side is hereinafter referred to as the “originating print server.” Otherwise, the print server 1 on the processing requested side is hereinafter referred to as the “other print server.” At least some of the jobs 210 are scheduled between the originating print server and the other print server. Then, the originating print server or the other print server that executes the process assigns the process of the job 210 to each component apparatus within the site, and it causes the process to be executed according to the schedule.

The printing apparatus 2 is an industrial printer including an image forming apparatus that performs small-lot printing, an automated industrial printing equipment that executes large quantities (multiple lots) printing such as offset printing, or the like.

The printing apparatuses 2 at each site according to the present embodiment may differ in the size, paper quality, color profile, recordable range, or the like, for the recording paper used in the printing process.

Further, the printing apparatus 2 at each site according to the present embodiment may be able to control the active and inactive states from the print server 1.

The post-processing apparatus 3 is a post-processing apparatus for performing post-processing processes such as folding, collating, bookbinding, cutting, and bookbinding on the recording paper printed by the printing apparatus 2.

Regarding the post-processing apparatuses 3 at each site according to the present embodiment, the content and range of processing that can be executed in the post-processing process may also be different.

Furthermore, the active and inactive states of the post-processing apparatus 3 at each site according to the present embodiment may also be able to be controlled from the print server 1.

The shipping server 4 is a server that manages shipping of orders sent from each site after the printing process or post-processing process is completed.

Although the present embodiment describes an example in which the shipping server 4 is provided at the site of company A, the shipping server 4 may also be provided at other sites.

The network 5 is a LAN (Local Area Network), a wireless LAN (Wi-Fi), a WAN (Wide Area Network), a mobile phone network, an industrial network, a voice telephone network, another dedicated line, or the like. The network 5 is capable of transmitting and receiving various commands and data to and from each apparatus. Furthermore, the print server 1 and each component apparatus may also be connected via a LAN, or the like, within the network 5. In addition, the network 5 may be configured with a VPN (Virtual Private Network), or the like.

Note that a plurality of these apparatuses may exist depending on the purpose, scale of printing, and the like. Each apparatus can be connected with the print server 1 via a network 5 by using various protocols. Alternatively, the print server 1 and each apparatus may be directly connected by wire using various interfaces.

In addition, each site may be provided with other component apparatuses managed by the print server 1. The other component apparatuses include, for example, a terminal for submitting manuscripts, a terminal for design proofreading, a prepress apparatus, and the like.

Additionally, an administrator terminal or a general terminal used by an administrator or a user may be connected via the network 5 from inside and outside each site. Thereby, each print server 1 can be accessed by the administrator or the user by using a web browser, a terminal, a dedicated application, or the like, from the administrator terminal, the general terminal, a console, or the like (Hereinafter, simply referred to as the “administrator terminal, or the like.”). Thereby, it is possible to perform a process of acquiring the job 210, designing printing, submitting a document, managing prepress processing, checking progress, requesting processing, and the like.

### [Control Configuration of Print Server 1]

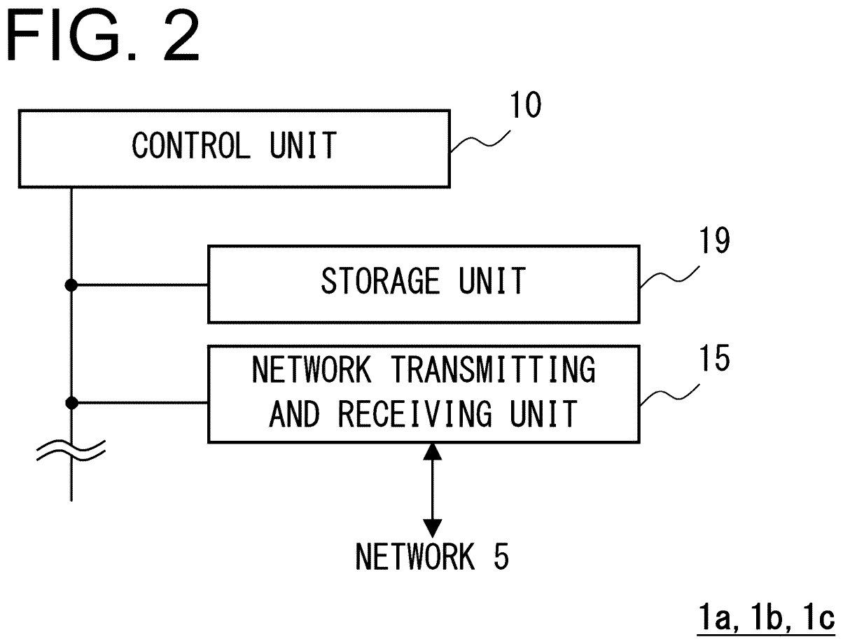

Next, with reference to FIG. 2, the control configuration of the print server 1 is described.

The print server 1 includes a control unit 10, a network transmitting and receiving unit 15, a storage unit 19, and the like. Each unit is connected with the control unit 10 and its operation is controlled by the control unit 10.

The control unit 10 an information processing unit such as a GPP (General Purpose Processor), a CPU (Central Processing Unit), an MPU (Micro Processing Unit), a DSP (Digital Signal Processor), a GPU (Graphics Processing Unit), and an ASIC (Application Specific Integrated Circuit, a processor for a specific application), or the like.

The control unit 10 reads a control program stored in the ROM or HDD of the storage unit 19, expands this control program in the RAM, and executes it, thereby operating as each unit of the functional blocks as described later. Further, the control unit 10 controls the entire apparatus according to instruction information input from an administrator terminal, or the like.

The network transmitting and receiving unit 15 is a network connecting unit including a LAN board, a wireless transmitting and receiving device, or the like, for connecting to the network 5.

The network transmitting and receiving unit 15 transmits and receives data over a data communication line, and it transmits and receives voice signals over a voice telephone line.

The storage unit 19 is a non-transitory recording medium such as a semiconductor memory such as a ROM (Read Only Memory) or a RAM (Random Access Memory), an HDD (Hard Disk Drive), or the like.

A control program for controlling the operation of the print server 1 is stored in the ROM or HDD of the storage unit 19.

The control program includes an OS (Operating System), middleware on the OS, services (daemons), various applications, database data, and the like. Among these, the various applications include the above-mentioned printing process management application.

In the present embodiment, the storage unit 19 stores processing programs and data of raster in-process (hereinafter simply referred as “rasterization” or “RIP”), which converts vector (line drawing) image data into printing image data (raster data). This rasterization processing program and data also include commercial libraries, fonts, and the like. In addition, the storage unit 19 also stores information on component apparatuses connected to the same printing line, control programs, and the like.

Furthermore, the storage unit 19 may also store account settings of the administrator or user of the industrial printing system X, other data, and the like.

Note that in the print server 1, the control unit 10 may be integrally formed, such as a CPU having a built-in GPU, a chip-on-module package, an SOC (System On a Chip), or the like.

Further, the control unit 10 may provide a built-in RAM, ROM, flash memory, or the like.

### [Functional Configuration of Print Server 1]

Here, with reference to FIG. 3, the functional configuration of the print server 1 is described.

The control unit 10 of the print server 1 includes a processing determination unit 100 and a processing management unit 110.

The storage unit 19 stores license information 200, a job 210, activation information 220, and estimation data 230.

The processing determination unit 100 determines the other print server that can process the job 210 based on the license information 200 stored in the storage unit 19.

Here, in the case of the originating print server that is the request source, the processing management unit 110 can cancel the processing request for the job 210 or choose to obtain another license when receiving output-not-enabled information, which is described later.

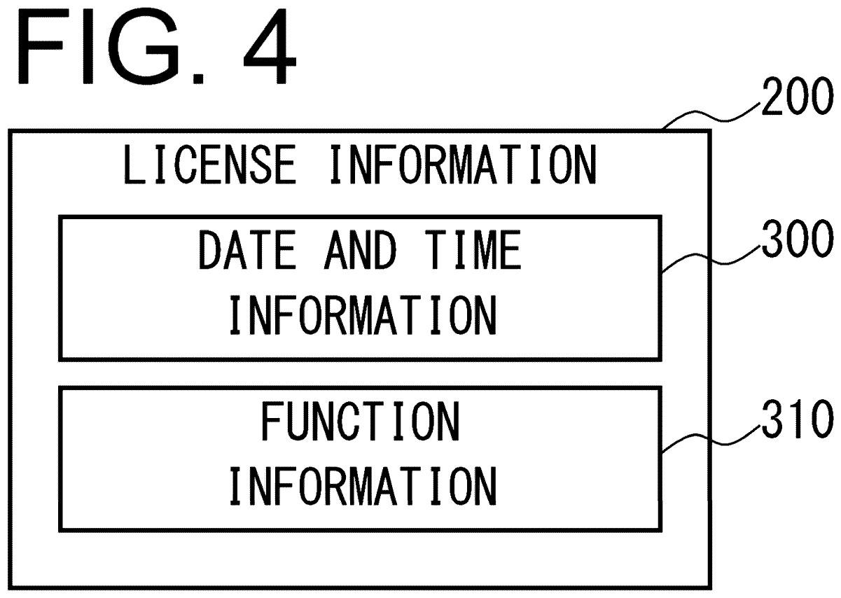

Specifically, the processing determination unit 100 can present the date and time information 300 and the function information 310 (FIG. 4) in the license information 200 to the user and make changes as part of acquiring the other license.

Alternatively, the processing determining unit 100 can also add and/or change the license information 200 depending on the content of the job 210.

The processing management unit 110 transmits the job 210 to the other print server determined to be capable of processing by the processing determination unit 100 and requests processing it. In this case, the processing management unit 110 may encrypt the job 210 by using a public key of the license information 200, or the like, and transmit the encrypted job 210.

In addition, in the present embodiment, the processing management unit 110 can also manage the processing of the job 210 by transmitting and receiving the license information 200 between a plurality of the print servers 1.

Furthermore, the processing management unit 110 can manage the processing of the job 210 by transmitting and receiving various notifications regarding the processing of the job 210 between the print servers 1.

Here, in the case of the other print server at the distribution destination, the processing management unit 110 can operate the connected component apparatus only at the date and time set in the date and time information 300 (FIG. 4) in the license information 200.

Otherwise, in the case of the other print server at the distribution destination, the processing management unit 110 can operate the connected component apparatus only for the function set in the license information 200.

Further, the processing management unit 110 of the other print server determines whether or not the job 210 can be outputted based on the settings of the license information 200. Then, if it is determined that the job 210 cannot be outputted, the processing management unit 110 of the other print server sends output-not-enabled information, which is the information indicating that the job 210 cannot be outputted, to the originating print server.

At this time, the processing management unit 110 of the other print server may calculate the estimation data 230 based on the license information 200 at the time of requesting processing. Based on this, the processing management unit 110 of the other print server can determine whether or not output is possible. As described later, the estimation data 230 includes the processing time and cost of the job 210.

The license information 200 is data to be licensed the date, time, function, or the like, available for utilizing the print server 1.

In the present embodiment, the license information 200 may be shared between the print servers 1. In other words, the license information 200 corresponding to the print server 1 (group) at each site that can be cooperated and distribution-processed is stored by each print server 1 in its storage unit 19.

The details of the license information 200 is described later.

The job 210 is a collected data of various data used during printing in production printing. The job 210 may be written in, for example, JDF (Job Description Format) and/or JMF (Job Messaging Format).

The details of the job 210 is also described later.

The activation information 220 is setting data, or the like, for activating or inactivating a connected component apparatus in the other print server at the distribution destination according to the license information 200 for the job 210. According to the activation information 220, the printing apparatus 2 and the post-processing apparatus 3 are activated or inactivated in the other print server, and the job 210 is processed or not.

The estimation data 230 is data of estimation indicating processing time, amount of consumables, cost, or the like, required for printing based on the license information 200. Among these, the amount of consumables includes amount of ink used, amount of paper used, license fee for a font and a spot color, and other consumables for printing and post-processing.

In addition, the estimation data 230 includes the value of the difference between the processing time calculated in the estimation and the actual processing time, the value of the difference between the amount of consumables calculated in the estimation and the actual amount of consumables, the value of the difference between the estimation cost and the actual cost, or the like. Further, the estimation data 230 may also include weighting data, such as historical data of these, or the like.

### (Details of License Information 200)

Then, with reference to FIG. 4, the details of the license information 200 is explained.

In the present embodiment, the license information 200 includes date and time information 300 and/or function information 310.

The date and time information 300 is information regarding the available date and time for distributed processing when the print server 1 becomes the other print server in the distribution destination.

In the present embodiment, the date and time information 300 may be a table, or the like, and it indicates the time in which the print server 1 and each component apparatus can be operated (activated).

The function information 310 is information regarding restrictions on functions that can be used for distributed processing when the print server 1 becomes a distribution destination.

In the present embodiment, the function information 310 includes rasterization restriction information, printing restriction information, and post-processing restriction information.

The rasterization restriction information is data indicating a usage restriction when performing rasterization in the print server 1. The rasterization restriction information includes, for example, color profile information, spot color information, font information, image processing information, and plug-in information.

Among there, the color profile information is information on a color gamut (color profile). The color profile information includes data such as an ICC profile, and the like.

The spot color information is information for specifying spot color(s), which is colors other than normal CMYK (Cyan, Magenta, Yellow, and Key plate). Specifically, the spot color information includes information on a commercial library related to color specification. The commercial library may include PANTONE (registered trademark) HKS, DIC (registered trademark), TOYO (registered trademark), and the like.

The font information is information such as a usable commercial font, and the like.

The image processing information is information indicating the image processing that can be performed and its capabilities. The image processing information includes, for example, information such as image enhancement, presence or absence of skew correction, and the like.

The plug-in information is information regarding plug-in processing. The plug-in information includes information on processing and capabilities of the plug-in, such as imposition, preflight, preflight profile, and the like.

The printing restriction information is data indicating usage restrictions when the printing apparatus 2 performs printing process. The print restriction information includes, for example, paper information, ink information, special printing information, resolution information, speed information, and the like.

The paper information includes information such as paper type, tray information, size, orientation, and the like. Furthermore, the paper information also includes information regarding restrictions on the usable paper type, the amount of paper used.

The ink information is information such as color, monochrome, other supported colors, spot colors, other special colors, and the like. Furthermore, the ink information also includes information regarding restrictions on the amount of ink used.

The special printing information includes, for example, special specifications such as embossing, a metallic color, a hologram, a UV curable ink, and the like.

The resolution information is information indicating the resolution at the time of printing. For example, values such as 600 dpi (dots per inch), 1200 dpi, or the like, are set as the resolution information.

The speed information is information regarding printing speed. For example, the speed information can be set such as the printing speed and its limits, or the like. As the printing speed, low speed or high speed may be set, or a value such as pages/second may be set.

In addition, the printing restriction information may include information regarding halftone, trapping, scaling, presence or absence of borderless printing, and other printing.

The post-processing restriction information is data indicating usage restrictions when performing post-printing process (post-processing) in the post-processing apparatus 3.

The cutting information includes whether cutting is possible or not, the maximum thickness, and other information necessary for cutting.

The folding information includes information such as whether folding is possible or not.

The bookbinding information includes information such as whether bookbinding is possible or not, and the types of possible bookbinding.

The post-processing restriction information may also include information regarding restrictions on the use of post-processing apparatuses other than these. For example, the post-processing restriction information may include information such as whether scoring, perforating, binding, or hole punching is possible or not.

In addition, the license information 200 may include data such as charge, payment, cost, billing, or the like, for printing (hereinafter simply referred to as “billing data”).

The billing data may be set corresponding to each of the date and time information 300 and the function information 310. For example, the basic cost, or the like, may be changed depending on the date and time. Further, in the printing restriction information, costs may be set for each of the rasterization restriction information, printing restriction information, and post-processing restriction information. Specifically, the billing data may be set the use of commercial fonts and special colors, the amount of ink used for each color, the cost for each paper, the cost for each type of post-processing, and the like.

Additionally, the billing data may include allowable cost data that are cost allowable for the user.

Furthermore, in addition to this, the license information 200 may also include data such as a unique ID (Identification), a public key, and an electronic certificate, for the corresponding print server 1.

Note that the license information 200 may include either or both of the date and time information 300 and/or the function information 310.

### (Details of Job 210)

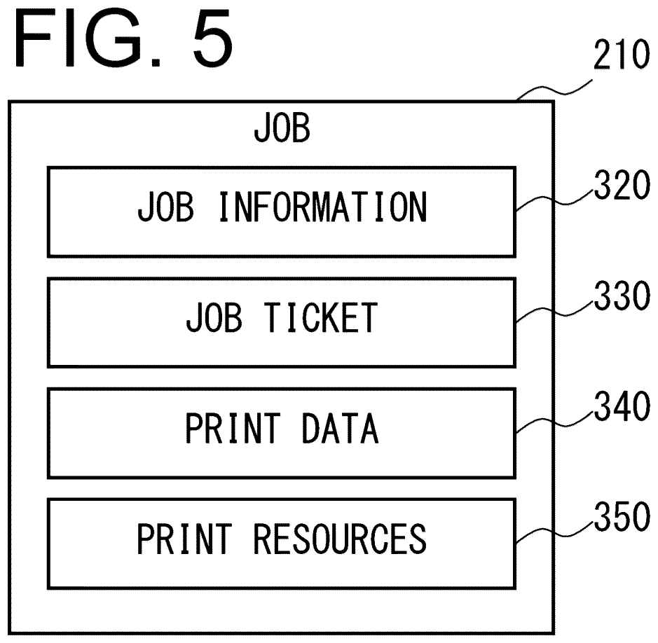

Then, with reference to FIG. 5, details of the job 210 is explained.

In the present embodiment, data used in the job 210 is mainly be described in the rasterization, printing process, and post-processing process.

The job 210 includes job information 320, job ticket 330, print data 340, print resources 350, and the like.

The job information 320 is data that includes an attribute specified in printing process (hereinafter referred to as a “specified attribute”). In the job information 320, as the specified attribute, the type of job 210, the name of the job 210, the name of the project (order), the specification of the printing apparatus 2 or the post-processing apparatus 3, the number of copies and whether or not to collate, whether or not to record, the trimming mm, printing direction, printing status, priority order, or the like, are set. Among these, the types of the job 210 include a job for printing process (print jobs) and a job for post-processing process (post-processing jobs).

The job ticket 330 is setting data that includes print instruction attributes for requesting the job 210. The job ticket 330 includes, as print instruction attributes, lower-level settings in the workflow that are settings for the order. These lower-level settings are necessary settings in the printing process and post-processing process, and they include, for example, color profile specification, imposition specification, paper specification, bookbinding specification, or the like. In the present embodiment, the job ticket 330 may include reservation information for specifying the printing apparatus 2 or the post-processing apparatus 3.

Further, the job ticket 330 may also be written in JDF and/or JMF.

The print data 340 is data of aprint document whose design is set according to the order. The print data 340 may be, for example, electronic document data such as PDF (Portable Document Format), PS (PostScript) data, other vector data, data in a submission format, other raster image data, or the like.

The print resources 350 is information on various resources necessary for printing instructions, such as a color profile, a spot color, a font, and the like. These various resources correspond to the license information 200.

Other resource data necessary for printing is also included in the print resources 350.

Furthermore, the job 210 may include image data that has been rasterized based on the job ticket 330. The image data may be, for example, TIFF or other bitmap data. Additionally, image data may be compressed reversibly or irreversibly.

In addition to this, the storage unit 19 may also store schedule information indicating the schedule status regarding the execution of each job 210. The schedule information may include, for example, schedules such as vacancy, tentative reservation for job 210, and busy reservation for job 210 in each time period of the printing process and the post-processing process.

Here, the control unit 10 of the print server 1 is made to function as a process determination unit 100 and a process management unit 110 by executing a control program stored in the storage unit 19.

Further, each part of the print server 1 described above becomes a hardware resource that executes the process management method according to the present disclosure.

In addition, a part or any combination of the above functional configurations may be configured in terms of hardware or circuitry by using an IC, programmable logic, FPGA (Field-Programmable Gate Array), or the like.

### [Licensing Distribution Job Process by Print Server 1]

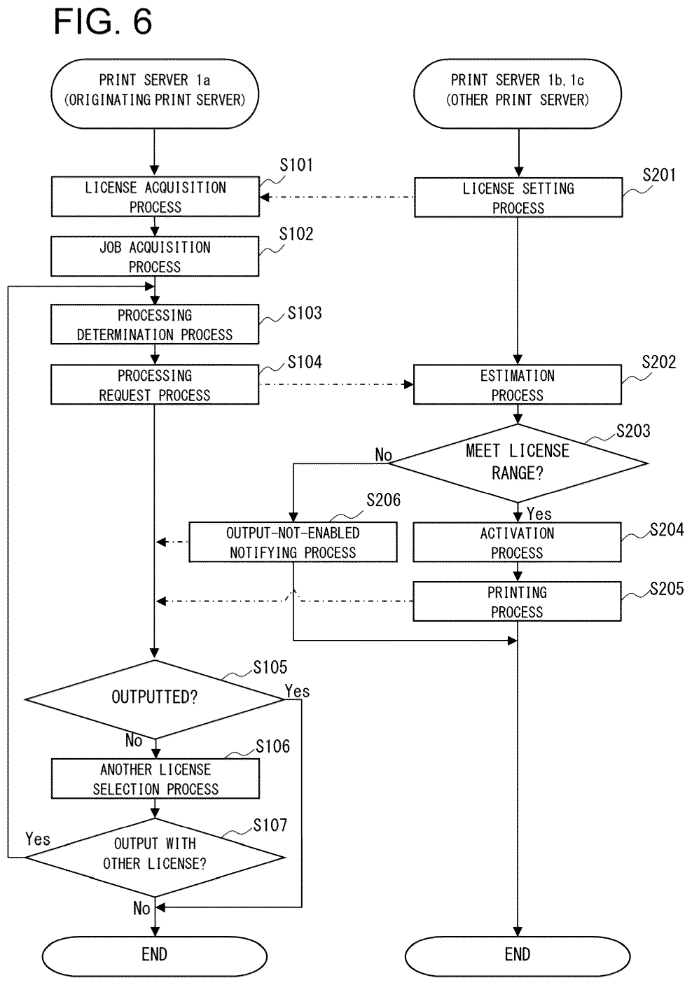

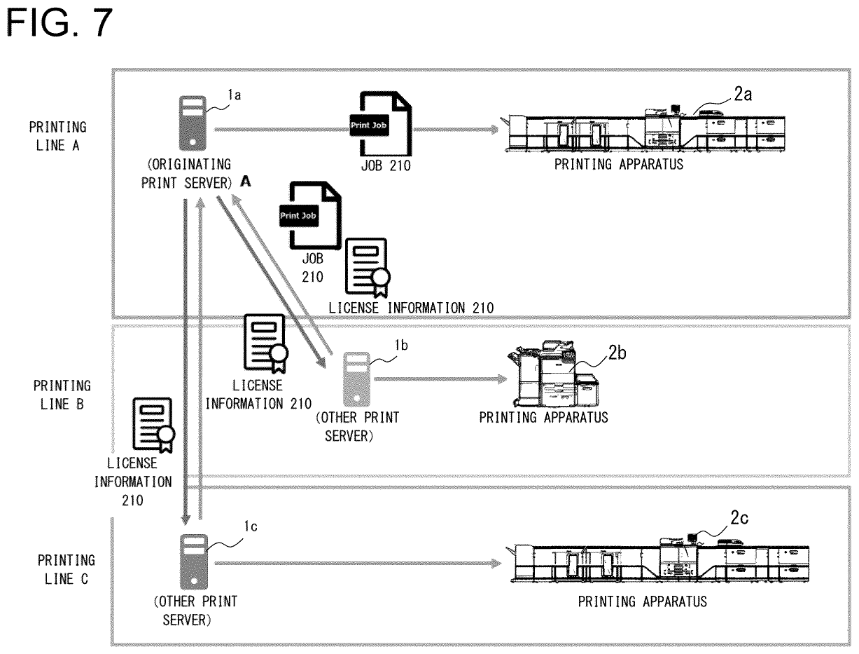

Next, with reference to FIGS. 6 and 7, a licensing distribution job process by the print server 1 according to the embodiment of the present disclosure is described.

In the licensing distribution job process of the present embodiment, license information 200 including available date and time information 300 and/or function information 310 for distributed processing is stored. Then, based on the stored license information 200, the other print server that can process the job 210 is determined. Then, the job 210 is sent to the other print server that is determined to be capable of processing, and a processing request is made.

In the licensing distribution job process according to the present embodiment, the print server 1a at the print line A (site) is the originating print server (processing request side) of the request source, and each of the print servers 1b and 1c at the print lines B and C (sites) is the other print server for the distribution destination. Thus, an example is described in which the control units 10 of these print servers 1a, 1b, and 1c execute programs stored in the storage unit 19 in cooperation with other units and by using hardware resources.

The details of licensing distribution job process is explained step by step below with reference to the flowchart of FIG. 6.

### (Step S201)

Firstly, the processing determination unit 100 of the other print server performs a license setting process.

The processing determination unit 100 generates license information 200 that includes date and time information 300, which sets the date and time when the distributed processing is available, and/or function information 310, which sets the available function, as the distribution destination.

Specifically, the processing determination unit 100 can generate license information 200 for printing on the other print servers at the distribution destination, and it can set available date and time information 300.

Alternatively, the processing determining unit 100 can specify available printing functions in the license information 200. At this time, restrictions on color profile information, spot color information, font information, image processing information, and plug-in information may be set in the rasterization restriction information. For example, the processing determination unit 100 can set usage restrictions for spot colors and special colors in the spot color information.

In addition, the processing determining unit 100 may set, for example, limitations on paper information, ink information, special printing information, resolution information, and speed information in the printing restriction information. For example, the processing determining unit 100 can set usage restrictions for special printing such as embossing in the special printing information. Further, the processing determining unit 100 can set a print speed limit in the speed information. This makes it possible to add value to high-speed printing by setting low speed as a specified value. Furthermore, the processing determination unit 100 can set restrictions on color or monochrome printing in the ink information. In addition to this, the processing determining unit 100 can also set in the ink information, for example, specification of the use of inks other than CMYK, such as pink, white, and transparent inks, restrictions on usable inks, and the like. In addition, the process determining unit 100 can set a limit on the amount of ink used in the ink information. Further, the processing determination unit 100 can set a limit on usable paper type in the paper information. Furthermore, the processing determination unit 100 can set a limit on the resolution that can be specified in the job 210 in the resolution information.

The processing determining unit 100 may set restrictions on the license information 200 based on information such as schedule information and costs for normal printing, or the like. For example, the processing determining unit 100 may increase the restrictions to ensure printing throughput if the schedule is crowded, and it may reduce the restrictions if the schedule is not busy.

Further, the processing determination unit 100 may cause the administrator terminal to execute a web browser or a dedicated application. Thereby, the process determining unit 100 may present the license information 200 to the administrator or the user of each print line by using a GUI (Graphical User Interface) on the screen of the dedicated application or the web browser. Then, the processing determining unit 100 can also acquire instructions from the administrator or the user, check and change the generated license information 200.

Furthermore, the processing determination unit 100 can transmit and receive the license information 200 between the plurality of print servers 1.

### (Step S101)

Here, the processing determination unit 100 of the originating print server performs a license acquisition process.

In this process, the processing determining unit 100 of the originating print server receives the license information 200 from the other print server and stores it in the storage unit 19.

### (Step S102)

Then, the processing determination unit 100 of the originating print server performs a job acquisition process.

The processing determination unit 100 acquires a job 210 to be subjected to peer-to-peer distributed processing from an inter-site management system, which is on upstream of the industrial printing system X, the administrator terminal, a prepress apparatus, or the like. The job 210 may be settable on the above-mentioned GUI for a manuscript submitted by a manuscript submission terminal.

In the example of the present embodiment, the print server 1a that has acquired this job 210 becomes the originating print server (processing requesting side, the print server 1 of requesting source).

### (Step S103)

Then, the process determination unit 100 performs a processing determination process.

The processing determination unit 100 determines the other print server that can process the job 210 based on the license information 200 stored in the storage unit 19.

At this time, the processing determination unit 100 analyzes the acquired job 210 and determines capability necessary for processing the job 210 (hereinafter referred to as a “processing requirement”). Specifically, the processing determination unit 100 determines the processing requirement in the printing process and the post-processing process from job information 320, print data 340, and print resources 350 included in the job 210. More specifically, the processing determination unit 100 determines, from the job information 320, color profile specification, imposition specification, paper specification, bookbinding specification, or the like, as the specified print instruction attributes. Furthermore, if the print data 340 is a PDF, or the like, the processing determining unit 100 determines the attributes specified in the print data 340. In addition, the processing determination unit 100 can also determine necessary processing requirements from the print resources 350. When checking these processing requirements, the processing determining unit 100 may also determine whether commercial library and plug-in processing are specified.

After determining the processing requirements, the processing determining unit 100 reads out the license information 200 of each print server 1 stored in the storage unit 19.

Here, if the license information 200 has not been acquired yet, the processing determination unit 100 acquires the license information 200 from the print server 1 of each site that can be linked for distributed processing. Then, the processing determination unit 100 may store the acquired license information 200 in the storage unit 19.

The processing determining unit 100 analyzes the license information 200 and selects one of the plurality of print servers 1 capable of processing the job 210 as the other print server. At this time, the processing determination unit 100 may select a print server 1 that is capable of printing at a lower cost based on the billing data of the license information 200 in addition to the processing requirements as described above. Alternatively, the processing determination unit 100 may select a print server 1 with a schedule that has some margin (not busy) based on the schedule information of each print server 1.

### (Step S104)

Then, the processing management unit 110 performs processing request process.

The processing management unit 110 transmits the job 210 to the other print server and requests processing.

With reference to the example of FIG. 7, the processing management unit 110 generates a job ticket 330 such as JDF and/or JMF, or the like, includes it in the job 210. The processing management unit 110 transmits this job 210 to the other print server that is determined to be able to process it with the license information 200 for the other print server.

At this time, the processing management unit 110 may encrypt the job 210 and the license information 200 by using the public key, or the like, included in the license information 200, and it may transmit the encrypted job 210 and the license information 200 to the other print server.

Further, before and after this processing request and processing, the processing management units 110 may send and receive a processing status notification and a completion notification for the job 210 between the originating print server and the other print server.

### (Step S202)

The processing of the other print servers is explained again. Here, the processing management unit 110 of the other print server performs an estimation process.

According to FIG. 7, upon receiving the job 210 and the license information 200 as a processing request, the processing management unit 110 calculates the processing time and cost of the job 210 based on the license information 200.

Specifically, the processing management unit 110 has received the license information 200 and stores it in the storage unit 19 as described above. Thus, the processing management unit 110 can decrypt the received license information 200 and compare it with the license information 200, private key, or the like, stored in the storage unit 19 of its own apparatus (the other print server). Thereby, the processing management unit 110 may confirm that the received information is based on an official license.

Based on this, the processing management unit 110 refers to the job information 320, the job ticket 330, the print data 340, and the print resources 350 in the job 210 as print settings, and it calculates the estimated processing time and estimated amount of consumables for this job 210.

At this time, the processing management unit 110 calculates the processing time and amount of consumables by adding the values set in the weighting data to the calculated estimated processing time and estimated amount of consumables. Then, the processing management unit 110 calculates the cost necessary for processing the job 210 based on the billing data of the license information 200. The processing management unit 110 generates estimation data 230 that includes the processing time, amount of consumables, and cost.

Based on this, the processing management unit 110 compares the processing time, amount of consumables, and cost set in this estimation data 230 with the allowable cost of the billing data of the date and time information 300 set in the license information 200. Then, the processing management unit 110 may check that it is within the range set in the license information 200.

Alternatively, the processing management unit 110 may compare the print settings of the job 210 with the billing data of the function information 310 of the license information 200, and it may check that the settings are within the range set in the license information 200.

Specifically, for the job 210, the processing management unit 110 may check color or monochrome printing, the type of ink specified, and the amount of ink used, and these are determined to be within the allowable cost range. At this time, the processing management unit 110 may check whether the amount of ink used by adding the value set in the weighting data is within the allowable cost or not. Further, the processing management unit 110 may check whether the cost of the paper specified in the job 210 is within the allowable cost or not.

### (Step S203)

Then, the processing determining unit 100 determines whether it meets within the license range or not.

In the above-described estimation process, the processing determination unit 100 determines Yes if the processing time and cost of the job 210 are within the license range. In other cases, that is, if it is not within the license range, the processing determining unit 100 determines No. This is a case when anyone of the date and time information 300 and the function information 310 does not satisfy the processing requirements, or the like. Further, if the license information 200 itself received from the originating print server is invalid, the determination may also be No.

In the case of Yes, the process determining unit 100 advances the process to step S204.

In the case of No, the process determining unit 100 advances the process to step S206.

### (Step S204)

If it is within the license range, the processing management unit 110 of the other print server performs activation process.

The processing management unit 110 has kept the acquired job 210 in the storage unit 19. Then, the processing management unit 110 activates the function set in the function information 310 according to the license at the date and time set in the date and time information 300 of the license information 200.

Specifically, the processing management unit 110 may set the activation information 220 to activate the printing apparatus 2 and/or the post-processing apparatus 3 only on the date and time set in the license information 200.

Further, the processing management unit 110 may set the activation information 220 so as to activate only the functions of the printing apparatus 2 and/or the post-processing apparatus 3 set in the license information 200. In this case, for example, if monochrome printing is set as the license in the print restriction information of the function information 310 in the license information 200, the processing management unit 110 may set the activation information 220 so that only the monochrome printing function of the printing apparatus 2 is activated. Thus, the processing management unit 110 may set the activation information 220 so that the color printing function, color adjustment function, and the like, of the printing apparatus 2 are inactivated.

### (Step S205)

Then, the processing management unit 110 performs printing process.

The processing management unit 110 executes rasterization, printing process, and post-processing processes on the acquired job 210, and outputs the process. At this time, the processing management unit 110 may cause the print data 340 after rasterization to be printed by the connected printing apparatus 2 and be post-processed by the post-processing apparatus 3.

Furthermore, after the processing of the job 210 is completed, the processing management unit 110 compares the processing time, amount of consumables, and cost in the data actually processed the job 210 with the processing time, amount of consumables, and cost in the estimation data 230, and the difference data (groups) may also be calculated. On this basis, the processing management unit 110 can calculate weighting values (groups) from the difference data (groups).

The processing management unit 110 may store the values in the weighting data of the estimation data 230 as for weighting to estimate the processing time, amount of consumables, and cost of the job 210.

Then, the processing management unit 110 may update the schedule information and send an output completion notification to the originating print server.

Thereafter, the processing determination unit 100 completes the licensing distribution job process on the other print servers.

### (Step S206)

Here, if the job 210 is not within the license range, the processing determination unit 100 performs an output-not-enabled notifying process.

The processing determination unit 100 may set the activation information 220 to be invalidated if it is not within the license range.

Then, the processing determining unit 100 determines that the output is not possible, and transmits output-not-enabled notification, which is information indicating that the output is not possible, to the originating print server.

At this time, the processing determination unit 100 may transmit the estimation data 230 and discrepancy content data indicating a part that is outside the range of the processing time and amount of consumables to the originating print server.

### (Step S105)

The processing of the originating print server is explained again.

Here, the processing determination unit 100 of the originating print server determines whether the job 210 is outputted or not.

If the above-mentioned output completion notification has been received, the processing determination unit 100 determines that the output has been completed and the result is Yes. In other cases, if the above-mentioned output-not-enabled notification has been received, the processing determination unit 100 determines that the output could not be performed and determines No.

In the case of Yes, the processing determination unit 100 completes the processing at the originating print server of the licensing distribution job process.

In the case of No, the process determining unit 100 advances the process to step S106.

### (Step S106)

If the output cannot be performed, the process determining unit 100 performs another license selection process.

If the job 210 requested to be processed does not meet within the range of the license information 200 and the output-not-enabled notification is received, the processing determination unit 100 can allow the user to select acquisition of the other license.

For example, the processing determination unit 100 may notify the user of the acquired discrepancy content data by using the GUI of the web browser or the dedicated application, and it may change the part that is not meet within the license range according to the user's instruction. Thereby, the process determining unit 100 can generate new license information 200 as the other license.

Alternatively, the processing determination unit 100 may analyze the contents of the job 210 and automatically change the license information 200.

In this case, for example, if the processing time of the date and time information 300 exceeds the allowable cost of the billing data, the processing determination unit 100 may change the allowable cost itself to match this, or it may change the date and time information 300 itself.

Alternatively, the processing determination unit 100 can also perform settings for replacing function that can be replaced. For example, if the color printing, spot color, embossing, or the like, in the function information 310 is not meet within the range of the license information 200 or exceeds the allowable cost of the billing data, or the like, the processing determination unit 100 may change the printing to be within the range, such as monochrome printing, no spot color, and no embossing, or the like.

Even when the license information 200 is automatically changed in this way, it is possible for the user to confirm the changes to the license information 200 by using the above-mentioned GUI.

The process determining unit 100 resets the user's selection into the license information 200 and stores it in the storage unit 19. When this license information 200 is changed, it may be transmitted from the originating print server to the other print servers and shared.

Alternatively, the processing determining unit 100 can refer again to the license information 200 of the plurality of print servers 1 and select a print server 1 that meets within the license range. This allows the user to select the alternative print server 1 as the other print server.

Alternatively, the processing determination unit 100 can cancel the processing request for the job 210 without setting the other license when the change cannot be made within the scope of the license or according to a user's instruction.

Furthermore, the processing determination unit 100 may be able to change the job 210 itself.

### (Step S107)

Then, the processing determining unit 100 determines whether or not to output using the other license.

The process determining unit 100 determines Yes if the license information 200 is changed or updated in the above-mentioned other license selection process. The processing determination unit 100 determines No in other cases, such as when the processing request for the job 210 is cancelled, when the job 210 itself is changed, or the like.

In the case of Yes, the processing determining unit 100 returns the process to step S103, selects the other print server for the changed job 210, and continues processing such as requesting processing. In this case, the same or not the same other print server is selected.

In the case of No, the processing determination unit 100 completes the licensing distribution job process.

With the above, the licensing distribution job process according to the embodiment of the present disclosure is completed.

As configured in this way, the following effects can be obtained.

In typical production printing, in order to efficiently process a large number of print jobs, the print jobs may be distributed and processed by a plurality of printing apparatuses.

In such distributed processing, in order to utilize the printing apparatuses at the distribution destinations, manual actions are required, such as coordinating the schedule of the printing apparatuses with the print line manager before requesting work, or the like. Thus, it takes time and effort to carry out distributed processing.

Therefore, in production printing, there is a need for technology that performs flexible and efficient peer-to-peer distributed processing without requiring manual intervention.

On the other hand, the industrial printing system X according to this embodiment is an industrial printing system that performs production printing having a plurality of print servers 1 that perform distributed processing of a job 210, each of the plurality of print servers 1 includes: a storage unit 19 that stores license information 200 having date and time information 300 and/or function information 310, which includes an available date and/or function at distribution destination for the distributed processing; a processing determination unit 100 that determines other print server capable of processing the job 210 based on the license information 200 stored in the storage unit 19; and a processing management unit 110 that sends the job 210 to the other print server determined to be capable of processing by the processing determination unit 100 and requests processing.

With this configuration, it is possible to perform efficient distributed processing without requiring manual intervention. In other words, the date and time, functions, or the like, which is available on the other print server at the distribution destination are licensed, and the originating print server at the request source obtains the license. This makes it possible to utilize the other print server at the distributed destination and its component apparatus.

Furthermore, as a peer-to-peer output management system based on a license, it is possible to easily schedule, or the like, mutually distributed processing not only between two sites but also between multiple sites. In addition, in peer-to-peer distributed processing, the use of distributed component apparatuses can be managed and controlled by using the license. Therefore, it becomes possible to easily use the printing apparatus 2 and the post-processing apparatus 3 at the distribution destination on a peer-to-peer basis.

Furthermore, when usage fees are incurred between the requester and the distribution destination, it is also possible to build a commercial flow by using licenses.

Further, the industrial printing system X according to the present embodiment can be configured as each print server 1 by simply storing the license information 200 in the existing print server 1 and installing the dedicated application, or the like. Then, the print servers 1 can cooperate with each other on a peer-to-peer basis. Therefore, it becomes possible to easily link sites such as existing companies, or the like, and it performs processing by using the license.

In the industrial printing system X according to the present embodiment, the processing management unit 110 of the other print server operates the connected component apparatus only for the date set in the date and time information 300 and/or the function set in the function information 310.

With this configuration, the printing apparatus 2 and the post-processing apparatus 3 can be activated based on the content of the license. As a result, costs can be reduced by not activating functions unrelated to the date and time when the job 210 is not processed and functions unrelated to the process.

In the industrial printing system X according to the present embodiment, the processing management unit 110 of the other print server determines whether or not the job 210 is possible to be outputted based on settings of the license information 200, and if outputting is not possible, allows the originating print server at the requesting source to choose whether to cancel a processing request for the job 210 or acquire another license.

With this configuration, even if the job 210 is not within the license range, it is possible to have the user reset the settings or cancel the job 210 itself. In addition, efficient distributed processing can be performed without changing the job 210 itself.

In the industrial printing system X according to the present embodiment, the processing management unit 110 transmits and receives the license information 200 between the plurality of print servers 1 and manages the processing of the job 210.

With this configuration, it is possible to determine the appropriate print server 1 to the other print server.

In addition, even if the job 210 is distributed and processed, it is possible to easily check at the originating print server whether the job 210 can be output or not. Therefore, it is possible to reliably execute distributed processing between printing lines, and it is possible to reduce labor and effort. Furthermore, by understanding the output of the job 210, it is also possible to adjust the processing request. As a result, it is possible to reduce the effort of manual adjustment, improve the efficiency of processing the job 210, and reduce running costs.

In the industrial printing system X according to the present embodiment, the processing management unit 110 of the other print server generates the estimation data 230 by calculating either of processing time, amount of consumables, and cost for the job 210 based on the license information 200 when requesting processing.

With this configuration, it is possible to compare the billing data of the license information 200 and the cost associated with actual processing of the job 210 and select more appropriate other print server. For example, the other print server that have long processing times but low costs, short processing times but high costs, fewer functions but low costs, and many functions but high costs can be selected by user's intention. Further, even if special “consumables” such as commercial library, or the like, is required to process the job 210, such cost can be calculated and applied.

Furthermore, by generating weighting data for the estimate data 230 after the other print server has actually outputted the job 210, more accurate costs can be calculated.

### Other Embodiments

In addition, in the above-described embodiment, an example has been described in which the license information 200 includes both the date and time information 300 and the function information 310.

However, either date and time information 300 or function information 310 may be included. In this case, it is possible to select the other print server based on either date and time or function and request processing. In addition, it is possible to activate the component apparatus on the other print server depending on the date and time or function depending on the license content.

By configuring in this way, a flexible configuration can be accommodated.

Furthermore, in the embodiment described above, the license information 200 is acquired from a plurality of print servers 1 before selecting the other print server. That is, in the embodiment described above, an example has been described in which the license information 200 of a plurality of print servers 1 is stored in the originating print server or acquired from the other print server.

However, the configuration may be such that the license information 200 is acquired each time from the print server 1 set as the other print server. That is, the license information 200 does not need to be stored in the originating print server. In this case, the other print server may be determined based on the processing requirements of the job 210 without depending on the license information 200. Alternatively, a configuration is also possible in which the originating print server determines only the processing requirements of the job 210, sends these processing requirements to the plurality of print servers 1 to determine whether they can process it. In such case, the print sever 1 that can process it sends the license information 200 to the originating print server. Each print server 1 may determine whether processing is possible based on the processing requirements of the job 210 and the license information 200 stored in its own storage unit 19.

Further, in the above-described embodiment, the license information 200 is described to include the content and conditions of the license, as well as actual license data.

However, a configuration is also possible in which setting data including the contents and conditions of the license and data about the license itself are set separately. In such case, only the license setting data may be acquired by the originating print server, and the license data itself, which may be a digital proof, or the like, may be acquired from the other print server each time.

With this configuration, it is possible to determine whether the job 210 can be processed without acquiring the license information 200 before selecting the other print server. Therefore, the effort of updating the license information 200, or the like, can be reduced, and a flexible configuration can be supported.

Further, in the above embodiment, an example has been described in which the other print server is determined from the originating print server without distinguishing between rasterization processing, print processing, and post-processing of the job 210.

However, separate print servers 1 (groups) serving as the other print server may be used for the printing step and the post-processing step.

In addition, priorities may be given as to which apparatus should perform rasterization processing, printing processing, and post-processing. The priority may be set based on the amount of availability according to schedule information, the number and performance of component apparatuses, cost, and other information.

With this configuration, it becomes possible to more efficiently distribute and process the job 210 to each site.

Further, in the above-described embodiment, an example is described in which the same license information 200 is selected regardless of the line of the requesting source.

However, it may be possible to set other license information 200 for each print server 1 of the requesting source. Further, it may be possible to change the license information 200 depending on the quantity, quality, or the like, of the requested jobs 210. For example, lower costs for “regular customers” may be set.

With this configuration, it becomes possible to bill a user for more appropriate fees, or the like.

Furthermore, in the embodiments described above, an example of distributed peer-to-peer processing has been described.

However, each process of the present embodiment can also be applied to a configuration by using a management server.

Also, as the terminology is used herein, the singular forms “a,” “an,” and “the” include plural forms unless the context clearly dictates otherwise.

Further, the configuration and operation of the embodiment described above are merely examples, and it goes without saying that the configuration and operation of the embodiment can be modified and executed as appropriate without departing from the aim of the present disclosure.

What is claimed is:

1. An industrial printing system that performs production printing having a plurality of print servers that perform distributed processing of a job, each of the plurality of print servers comprising;
a storage unit configured to store license information having function information of an available distribution destination for the distributed processing;
a processing determination unit configured to determine other print server capable of processing the job based on the license information stored in the storage unit; and
a processing management unit configured to send the job to the other print server determined to be capable of processing by the processing determination unit and requests processing.

2. The industrial printing system according to claim 1, wherein:
the processing management unit of the other print server operates the connected component apparatus only for the function set in the license information.

3. The industrial printing system according to claim 1, wherein:
the processing management unit of the other print server determines whether or not the job is possible to be outputted based on settings of the license information, and when outputting is not possible, allows requesting print server to choose whether to cancel a processing request for the job or acquire another license.

4. The industrial printing system according to claim 1, wherein:
the processing management unit transmits and receives the license information between the plurality of print servers and manages processing of the job.

5. The industrial printing system according to claim 1, wherein:
the processing management unit of the other print server calculates the processing time and cost of the job based on the license information when requesting processing.

6. A print server that performs distributed processing of a job in an industrial printing system that performs production printing, comprising:
a storage unit configured to store license information having function information of an available distribution destination for the distributed processing;
a processing determination unit configured to determine other print server capable of processing the job based on the license information stored in the storage unit;
a processing management unit configured to send the job to the other print server determined to be capable of processing by the processing determination unit and requests processing.

7. The print server according to claim 6, wherein:
the processing management unit of the other print server operates the connected component apparatus only for the function set in the license information.

8. The print server according to claim 6, wherein:
the processing management unit of the other print server determines whether or not the job is possible to be outputted based on settings of the license information, and when outputting is not possible, allows requesting print server to choose whether to cancel a processing request for the job or acquire another license.

9. The print server according to claim 6, wherein:
the processing management unit transmits and receives the license information between the plurality of print servers and manages processing of the job.

10. The print server according to claim 6, wherein:
the processing management unit of the other print server calculates the processing time and cost of the job based on the license information when requesting processing.

11. A processing management method executed by an industrial printing system that performs production printing and has a plurality of print servers that perform distributed processing of jobs, comprising the steps of:
storing license information having function information of an available distribution destination for the distributed processing;
determining other print server capable of processing the job based on the stored license information;
sending the job to the other print server that is determined to be capable of processing; and
requesting processing the job.

12. The processing management method according to claim 11, further comprising a step of:
in the other print server, operating the connected component apparatus only for the function set in the license information.

13. The processing management method according to claim 11, further comprising steps of:
in the other print server, determining whether or not the job is possible to be outputted based on settings of the license information, and
in the requesting print server, when outputting is not possible, allowing requesting print server to choose whether to cancel a processing request for the job or acquire another license.

14. The processing management method according to claim 11, further comprising a step of:
transmitting and receiving the license information between the plurality of print servers and managing processing of the job.

15. The processing management method according to claim 11, further comprising a step of:
in the other print server, calculating the processing time and cost of the job based on the license information when requesting processing.
